(19) United States
(12) Patent Application Publication
(10) Pub. No.: US 2012/0005162 A1
(43) Pub. Date: Jan. 5, 2012

(54) Managing Copies of Data Structures in File Systems

(75) Inventors: Janet E. Adkins, Austin, TX (US); Joon Chang, Austin, TX (US); David J. Craft, Wimberly, TX (US)

(73) Assignee: INTERNATIONAL BUSINESS MACHINES CORPORATION, Armonk, NY (US)

(21) Appl. No.: 12/827,430

(22) Filed: Jun. 30, 2010

(51) Int. Cl. G06F 17/00

(52) U.S. Cl. 707/639; 707/812; 707/E17.01; 707/E17.044

(57) ABSTRACT

A method, data processing system, and computer program product for managing data. A processor unit copies a data structure within a hierarchy of data structures to form a copy of the data structure. The data structure belongs to a level within a plurality of levels in the hierarchy of data structures. The processor unit associates an identifier with the data structure within the hierarchy of data structures. The processor unit increments a portion of the identifier for the data structure in response to copying the data structure to form the copy of the data structure and associating the identifier with the data structure within the hierarchy of data structures. The portion of the identifier that is incremented is based on the level within the plurality of levels in which the data structure is located.

### BACKGROUND

1. Field

The present disclosure relates generally to an approved data processing system and, in particular, to a method and apparatus for processing data. Still more particularly, the present disclosure relates to a method and apparatus for managing snapshots or clones of files.

2. Description of the Related Art

A file system is a method for storing and organizing data. In particular, a file system may organize data and files into a database. The file system also associates metadata with each file. The metadata describes various characteristics of the file, such as the length of data in a file, a user identifier, access permissions, and/or other suitable information. File systems are often hierarchical, in which different levels are present. For example, various levels of directories may be present with files located in different levels of the subdirectories.

Copies of file systems may be made for a number of different purposes. For example, copies of a file system may be made for use in data backup and disaster recovery. Copies of file systems also may be used to generate a copy of a file system at a particular point in time. These types of copies may be referred to as a snapshot. With a snapshot, the file system may be returned to the state at the time at which the snapshot was generated. In other cases, copies of a file system may be made to allow for changes to be made to those copies instead of the original file system. These types of copies may be referred to as clones.

### SUMMARY

The different illustrative embodiments provide a method, data processing system, and computer program product for managing data. A processor unit copies a data structure within a hierarchy of data structures to form a copy of the data structure. The data structure belongs to a level within a plurality of levels in the hierarchy of data structures. The processor unit associates an identifier with the data structure within the hierarchy of data structures. The processor unit increments a portion of the identifier for the data structure in response to copying the data structure to form the copy of the data structure and associating the identifier with the data structure within the hierarchy of data structures. The portion of the identifier that is incremented is based on the level within the plurality of levels in which the data structure is located.

### BRIEF DESCRIPTION OF THE SEVERAL VIEWS OF THE DRAWINGS

FIG. 1 is an illustration of a network of data processing systems in which illustrative embodiments may be implemented;

FIG. 2 is an illustration of a data processing system in accordance with an illustrative embodiment;

FIG. 3 is an illustration of a data management environment in accordance with an illustrative embodiment;

FIG. 4 is an illustration of a hierarchy of data structures in accordance with an illustrative embodiment;

FIG. 5 is an illustration of a progression of data structures in accordance with an illustrative embodiment;

FIG. 6 is an illustration of a progression of data structures in accordance with an illustrative embodiment;

FIG. 7 is an illustration of a flowchart of a process for managing data in accordance with an illustrative embodiment; and

FIG. 8 is an illustration of a flowchart of a process for managing data in accordance with an illustrative embodiment.

### DETAILED DESCRIPTION

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, the present invention may take the form of a computer program product embodied in any tangible medium of expression having computer usable program code embodied in the medium.

Any combination of one or more computer usable or computer readable medium(s) may be utilized. The computer usable or computer readable medium may be, for example, but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media, such as those supporting the Internet or an intranet, or a magnetic storage device.

Note that the computer usable or computer readable medium could even be paper or another suitable medium upon which the program is printed, as the program can be electronically captured via, for instance, optical scanning of the paper or other medium, then compiled, interpreted, or otherwise processed in a suitable manner, if necessary, and then stored in a computer memory. In the context of this document, a computer usable or computer readable medium may be any medium that can contain, store, communicate, propagate, or transport the program for use by or in connection with the instruction processing system, apparatus, or device. The computer usable medium may include a propagated data signal with the computer usable program code embodied therewith, either in baseband or as part of a carrier wave. The computer usable program code may be transmitted using any appropriate medium including, but not limited to, wireless, wireline, optical fiber cable, RF, etc.

Computer program code for carrying out operations of the present invention may be written in any combination of one or more programming languages, including an object-oriented programming language, such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowcharts and/or block diagrams of methods, apparatus (systems), and computer program products according to embodiments of the invention. It will be understood that each block of the flowcharts and/or block diagrams, and combinations of blocks in the flowcharts and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The different illustrative embodiments recognize and take into account a number of considerations. For example, the different illustrative embodiments recognize and take into account that in creating copies of file systems, the copies may take a number of different forms. For example, a snapshot or a clone of a file system may be made. A snapshot of the file system is a copy that is not modifiable. A clone of a file system is a copy of the file system that can be modified in these illustrative examples.

With respect to a clone of a file system, the clone may allow changes based on the original file system from which the clone was made.

The different illustrative embodiments recognize and take into account that currently, support for persistent snapshots or clones of files is not present. The different illustrative embodiments recognize and take into account that allowing different granularities of control may be desirable. For example, the different illustrative embodiments recognize and take into account that allowing a persistent snapshot or clone to be made of a file provides a user or program greater control over data. For example, with this type of granularity, a user does not have to depend on a system administrator to generate snapshots.

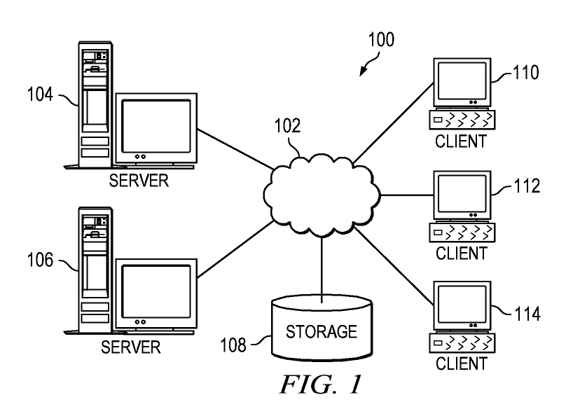

With reference now to the figures and, in particular, with reference to FIG. 1, an illustration of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts an illustration of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer recordable storage medium and downloaded to a data processing system or other device for use. For example, program code may be stored on a computer recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

In the different illustrative embodiments, copies of data located on different computers may be made. For example, a copy of data on server computer 104 may be made and stored on server computer 104. In other illustrative examples, the copy of the data may be stored in other locations, such as storage unit 108, server computer 106, client computer 110, or other suitable types of computers. In these examples, the copies of data may be copies of file systems. These copies may take different forms, such as, for example, without limitation, a snapshot, a clone, or some other suitable type of copy of data. In the different illustrative embodiments, a method and apparatus is provided to manage copies of data. The management of these copies of data may take the form of entire file systems, portions of file systems, individual files, directories, and other suitable types of data in different groupings and collections.

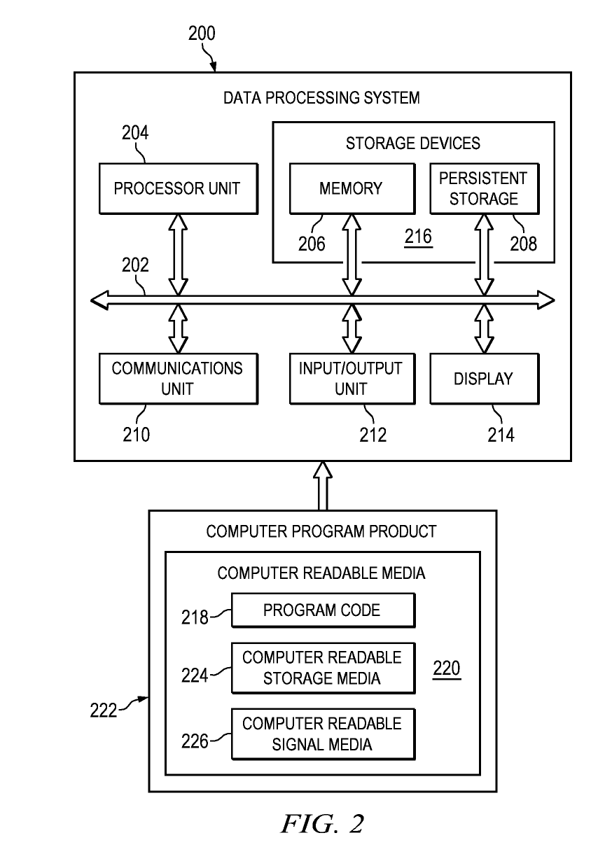

Turning now to FIG. 2, an illustration of a data processing system is depicted in accordance with an illustrative embodiment. In this illustrative example, data processing system 200 includes communications fabric 202, which provides communications between processor unit 204, memory 206, persistent storage 208, communications unit 210, input/output (I/O) unit 212, and display 214. Data processing system 200 is an example of a data processing system in which copies of data may be made. Data processing system 200 is an example of one implementation for server computers and client computers in network data processing system 100 in FIG. 1.

Processor unit 204 serves to run instructions for software that may be loaded into memory 206. Processor unit 204 may be a number of processors, a multi-processor core, or some other type of processor, depending on the particular implementation. A number, as used herein with reference to an item, means one or more items. Further, processor unit 204 may be implemented using a number of heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a temporary basis and/or a permanent basis. Storage devices 216 may also be referred to as computer readable storage devices in these examples. Memory 206, in these examples, may be, for example, a random access memory or any other suitable volatile or non-volatile storage device. Persistent storage 208 may take various forms, depending on the particular implementation.

For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In these illustrative examples, the instructions are in a functional form on persistent storage 208. These instructions may be loaded into memory 206 or run by processor unit 204. The processes of the different embodiments may be performed by processor unit 204 using computer implemented instructions, which may be located in a memory, such as memory 206.

These instructions are referred to as program code, computer usable program code, or computer readable program code that may be read and run by a processor in processor unit 204. The program code in the different embodiments may be embodied on different physical or computer readable storage media, such as memory 206 or persistent storage 208.

Program code 218 is located in a functional form on computer readable media 220 that is selectively removable and may be loaded onto or transferred to data processing system 200 and run by processor unit 204. Program code 218 and computer readable media 220 form computer program product 222 in these examples. In one example, computer readable media 220 may be computer readable storage media 224 or computer readable signal media 226. Computer readable storage media 224 may include, for example, an optical or magnetic disk that is inserted or placed into a drive or other device that is part of persistent storage 208 for transfer onto a storage device, such as a hard drive, that is part of persistent storage 208. Computer readable storage media 224 also may take the form of a persistent storage, such as a hard drive, a thumb drive, or a flash memory, that is connected to data processing system 200. In some instances, computer readable storage media 224 may not be removable from data processing system 200. In these illustrative examples, computer readable storage media 224 is a non-transitory computer readable storage medium.

Alternatively, program code 218 may be transferred to data processing system 200 using computer readable signal media 226. Computer readable signal media 226 may be, for example, a propagated data signal containing program code 218. For example, computer readable signal media 226 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 218 may be downloaded over a network to persistent storage 208 from another device or data processing system through computer readable signal media 226 for use within data processing system 200. For instance, program code stored in a computer readable storage medium in a server data processing system may be downloaded over a network from the server to data processing system 200. The data processing system providing program code 218 may be a server computer, a client computer, or some other device capable of storing and transmitting program code 218.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 220 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206, or a cache, such as found in an interface and memory controller hub that may be present in communications fabric 202.

The different illustrative embodiments recognize and take into account a number of different considerations. For example, the different illustrative embodiments recognize and take into account that it may be desirable to manage copies of data that may not be a copy of an entire file system. For example, the different illustrative embodiments recognize and take into account that copies of file systems may be taken on some scheduled basis. For example, system administrators may copy an entire file system in the form of a snapshot to provide for an ability to restore the file system to a prior state. The different illustrative embodiments also recognize and take into account that it may be desirable to have a higher level of granularity in making copies. For example, the different illustrative embodiments recognize and take into account that it may be desirable to take a snapshot of a particular file, a directory, a directory with subdirectories, or some other subset of a file system. In this manner, a user does not have to depend on a schedule set by a system administrator to make snapshots of data.

Thus, the different illustrative embodiments provide a method and apparatus for managing data. An identifier is associated with each data structure in a hierarchy of data structures. Each data structure in the hierarchy of data structures belongs to a level within a plurality of levels in the hierarchy of data structures. A data structure is copied within the hierarchy of data structures after associating the identifier with each data structure within a hierarchy of data structures to form a copy of the data structure. Responsive to copying the data structure within the hierarchy of data structures, a portion of an identifier for the copy of the data structure is incremented for the copy of the data structure. The portion of the identifier that is incremented is based on the level in the plurality of levels in which the data structure is located.

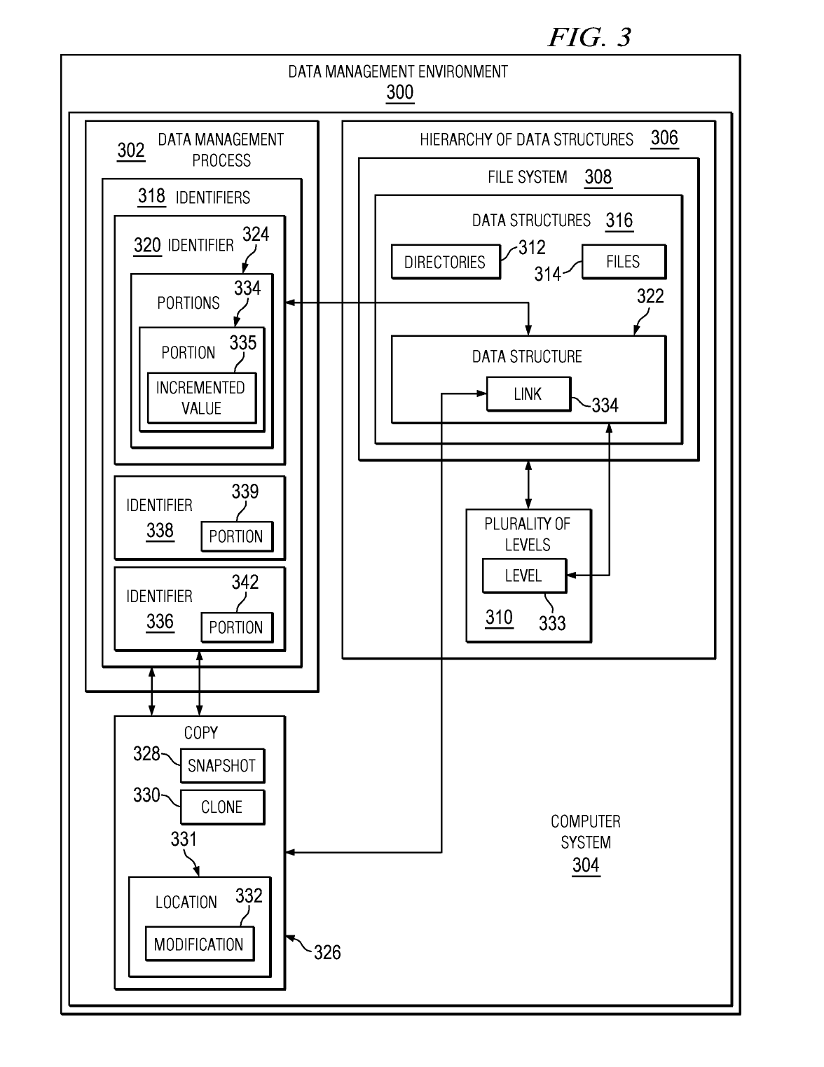

With reference now to FIG. 3, an illustration of a data management environment is depicted in accordance with an illustrative embodiment. Data management environment 300 may be implemented in network data processing system 100 in FIG. 1. In some illustrative examples, data management environment 300 may be located within a single computer, such as data processing system 200 in FIG. 2.

In these illustrative examples, data management process 302 runs in computer system 304. Computer system 304 may take the form of a number of computers. When more than one computer is present in computer system 304, the computers are in communication with each other.

Data management process 302 may be used to manage hierarchy of data structures 306. Hierarchy of data structures 306 may take various forms. In these illustrative examples, hierarchy of data structures 306 takes the form of file system 308. Hierarchy of data structures 306 has plurality of levels 310. Plurality of levels 310 may be levels for directories 312 and files 314.

Directories 312 and files 314 are examples of data structures 316 within hierarchy of data structures 306. Additionally, a data structure within data structures 316 may be a file, a directory, a directory including files and subdirectories with the directory, or some other suitable organization of data. In these illustrative examples, a subdirectory may include subdirectories of the subdirectory and/or files.

In these illustrative examples, data management process 302 associates identifiers 318 with data structures 316. In other words, each data structure within data structures 316 in hierarchy of data structures 306 is associated with an identifier in identifiers 318. Identifiers 318 include different portions for a data structure. For example, identifier 320 is associated with data structure 322. Identifier 320 has portions 324. Each portion within portions 324 may be associated with a particular level in which data structure 322 is located. Each of portions 324 is set to a certain value in this example.

In these illustrative examples, data management process 302 may be used to copy data structure 322 within hierarchy of data structures 306. Identifier 320 may be associated with data structure 322 after the copy of data structure 322 is formed, during the copying of data structure 322, or before the copy of data structure 322 is formed. When data structure 322 is a file or directory, associating identifier 320 with data structure 322 may include assigning initial values to portions 324 of identifier 320.

As one illustrative example, data management process 302 may copy data structure 322 to form copy 326 of data structure 322. Copy 326 may take the form of snapshot 328, clone 330, or some other suitable type of copy in these examples. Copying data structure 322 may include identifying location 331 for making modification 332 for data structure 322, creating link 334 from data structure 322 to copy 326, associating a header with an identifier with copy 326, and/or performing other suitable operations. Link 334 may take the form of, for example, a pointer.

When copy 326 is created and after identifier 320 is associated with data structure 322, portion 334 in portions 324 of identifier 320 is incremented. The portion in portion 324 that is incremented is based on the level within plurality of levels 310 in which data structure 322 is located. Data structure 322 is located in level 333 in plurality of levels 310. Portion 334 is associated with level 333 in plurality of levels 310. Further, portion 334 is incremented by setting portion 334 to incremented value 335. Incremented value 335 is formed by incrementing a value for portion 339 of identifier 338 associated with data structure 322. Portion 339 is also associated with level 333 for data structure 322.

Additionally, identifier 336 is associated with copy 326. Portion 342 of identifier 336 is also associated with level 333 for data structure. Portion 342 takes the value for portion 339 of identifier 338 associated with data structure 322. In this manner, portion 342 of identifier 336 for copy 326 remains unchanged from portion 339 of identifier 338.

In these illustrative examples, after copy 326 is formed, modification 332 for data structure 322 may be stored in location 331. Modification 332 may be a delta of the difference between copy 326 and data structure 322 after modification 332 has been made.

The illustration of data management environment 300 in FIG. 3 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

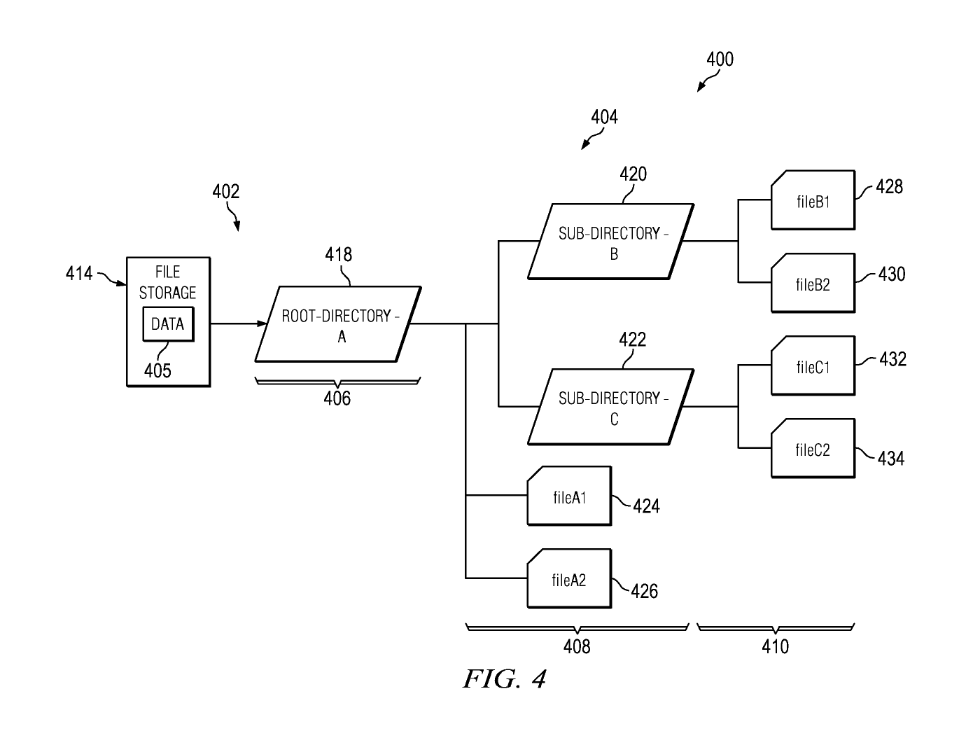

With reference now to FIG. 4, an illustration of a hierarchy of data structures is depicted in accordance with an illustrative embodiment. In this illustrative example, hierarchy of data structures 400 is an example of one implementation for hierarchy of data structures 306 in FIG. 3. Hierarchy of data structures 400 has plurality of levels 402 for data structures 404 in this example. Data structures 404 are examples of implementations for data structures 316 in FIG. 3.

In these illustrative examples, each of data structures 404 contains information about data 405 in file storage 414. Data 405 comprises blocks of data that are stored in file storage 414. Data 405 includes, for example, the data contained in files, directories, and subdirectories. File storage 414 may take the form of, for example, without limitation, persistent storage 208 in FIG. 2, computer readable storage media 224 in FIG. 2, and/or some other suitable type of storage device.

Data structures 404 contain information, such as, for example, pointers that point to the location of data 405 in file storage 414, type of file, permissions, ownership information, and/or other suitable types of basic information about data 405. Data structures 404 include root directory A 418, subdirectory B 420, subdirectory C 422, file A1 424, file A2 426, file B1 428, file B2 430, file C1 432, and file C2 434. Each of these data structures corresponds to blocks of data within data 405.

As depicted, plurality of levels 402 includes first level 406, second level 408, and third level 410. Root directory A 418 is in first level 406. Root directory A 418 includes subdirectory B 420, subdirectory C 422, file A1 424, and file A2 426, which are all in second level 408. Subdirectory B 420 includes file B1 428 and file B2 430 in third level 410. Subdirectory C 422 includes file C1 432 and file C2 434 in third level 410.

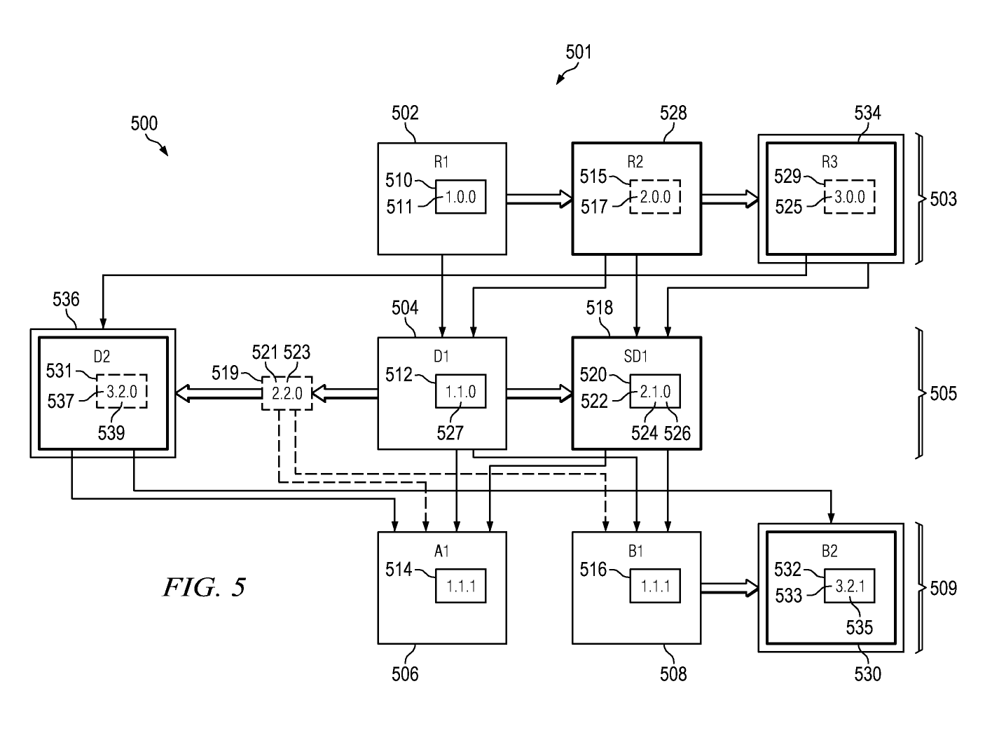

With reference now to FIG. 5, an illustration of a progression of data structures is depicted in accordance with an illustrative embodiment. In this depicted example, data structures 500 are examples of implementations for data structures 316 in FIG. 3. In this illustrative example, data structures 500 may take the form of, without limitation, inodes.

As depicted, data structures 500 are organized in plurality of levels 501. Plurality of levels 501 includes first level 503, second level 505, and third level 509. Root directory R1 502 is in first level 503. Root directory R1 502 points to directory D1 504. Directory D1 504 is in second level 505. Directory D1 504 points to file A1 506 and file B1 508. File A1 506 and file B1 508 are in third level 509. In these examples, a data structure may point to a second data structure by having a link to the second data structure. The link may be, for example, a pointer.

Root directory R1 502, directory D1 504, file A1 506, and file B1 508 are written to disk in this illustrative example. A data structure that is written to disk is physically and/or virtually stored in a storage device. The storage device may take the form of, for example, without limitation, persistent storage, a computer readable storage medium, an optical disk, a virtual storage device, a tape recording device, or some other suitable type of storage device.

In this illustrative example, root directory R1 502 is associated with identifier 510. Directory D1 504 is associated with identifier 512. File A1 506 is associated with identifier 514, and file B1 508 is associated with identifier 516. Each of these identifiers has three portions. Each portion is associated with a level in plurality of levels 501. These identifiers may be, for example, contained in headers associated with the data structures.

Root directory R1 502 is the highest level in plurality of levels 501. In these examples, once root directory R1 502 is formed and written to disk, root directory R1 502 is associated with identifier 515. Identifier 515 is stored in memory, such as memory 206 in FIG. 2. In other words, identifier 515 has not yet been written to disk. Identifier 515 has first portion 517. First portion 517 is associated with first level 503. First portion 517 of identifier 515 is set to an incremented value formed by incrementing first portion 511 of identifier 510.

In this illustrative example, a copy of directory D1 504 in second level 505 is formed. In particular, snapshot SD1 518 is created. In these examples, the data structure is created by forming the data structure and writing the data structure to disk.

Snapshot SD1 518 is created in a new location separate from the location for directory D1 504. Further, snapshot SD1 518 contains a copy of the information in directory D1 504. Snapshot SD1 518 is associated with identifier 520. Identifier 520 has first portion 522 associated with first level 503, second portion 524 associated with second level 505, and third portion 526 associated with third level 509.

First portion 522 is set to the value for first portion 517 of identifier 515 stored in memory. Second portion 524 and third portion 526 are set to the values for the second and third portions of identifier 512 for directory D1 504. In this manner, second portion 524 and third portion 526 remain unchanged. Additionally, snapshot SD1 518 points to file A1 506 and file B1 508. Modifications may not be made to snapshot SD1 518.

When snapshot SD1 518 is created, directory D1 504 is associated with identifier 519. Identifier 519 is also stored in memory and not yet written to disk. First portion 521 of identifier 519 takes the value of first portion 517 of identifier 515 stored in memory. Second portion 523 of identifier 519 is incremented. This incrementing is performed by incrementing the value for second portion 527 of identifier 512 associated with directory D1 504 to form an incremented value. Second portion 523 of identifier 519 is set to this incremented value.

Additionally, root directory R2 528 is formed and written to disk. Root directory R2 528 contains the information in root directory R1 502 and is associated with identifier 515. Root directory R2 528 also contains any modifications that have been made for root directory R1 502 between the creation of root directory R1 502 and the creation of root directory R2 528. Root directory R2 528 is in a new location separate from root directory R1 502. Further, root directory R2 528 points to directory D1 504 and snapshot SD1 518. Additionally, when root directory R2 528 is formed, identifier 529 is associated with root directory R2 528 and stored in memory. First portion 525 is set to an incremented value formed by incrementing the value for first portion 517 of identifier 515.

Further, when root directory R2 528 is formed, identifier 519 remains stored in memory. In other words, identifier 519 is not written to disk when root directory R2 528 is written to disk.

In this illustrative example, modifications may be made to file B1 508 after the creation of snapshot SD1 518. A new location is identified for these modifications. These modifications are stored in file B2 530 in this new location.

File B2 530 is associated with identifier 532. First portion 533 of identifier 532 takes the value of first portion 525 of identifier 529. Second portion 535 of identifier 532 takes the value of second portion 523 of identifier 519 stored in memory. When file B2 530 is created, directory D2 536 is created. Directory D2 536 is associated with identifier 531. Directory D2 536 points to file Al 506 and file B2 530.

First portion 537 of identifier 531 is set to the value of first portion 525 of identifier 529. Second portion 539 of identifier 531 is set to the value of second portion 523 of identifier 519.

Further, root directory R3 534 is also created and written to disk when file B2 530 is created. Root directory R3 534 is associated with identifier 529. Root directory R3 534 points to directory D2 536 and snapshot SD1 518. In this manner, the most recent copy of the root directory points to the most recent copy of the directory and the snapshot written to disk.

In these examples, the second portions and third portions of identifiers 510, 515, and 529 are set to zero as a result of the second and third levels not being present at the level for root directory R1 502. The third portions of identifiers 512, 519, 520, and 531 are set to zero as a result of the third level not being present at the level for directory D1 504.

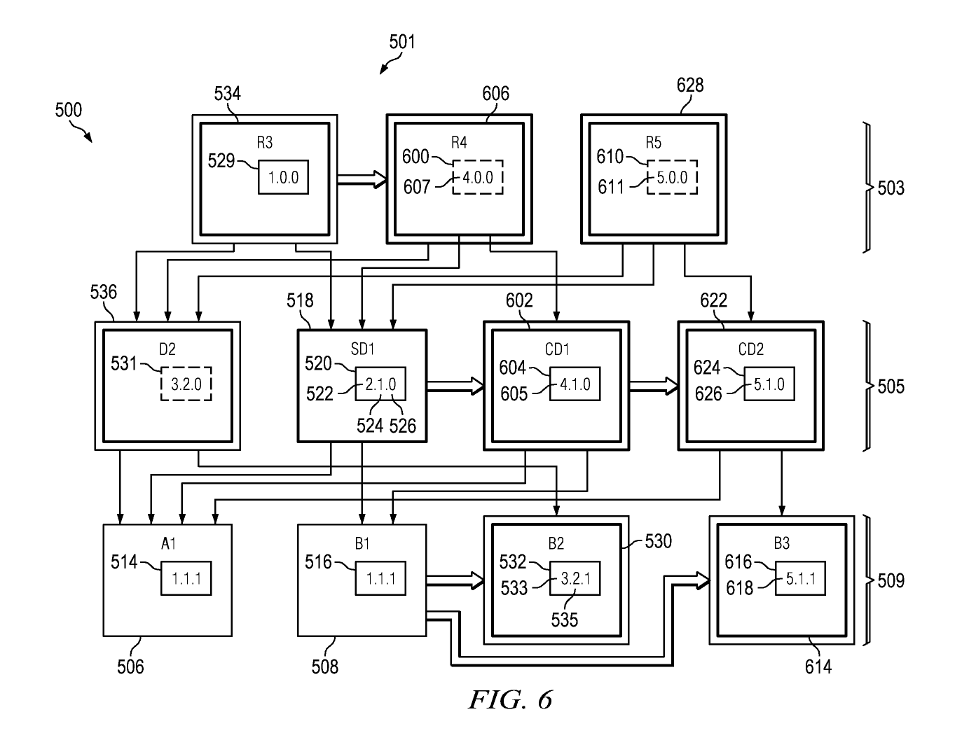

With reference now to FIG. 6, an illustration of a progression of data structures is depicted in accordance with an illustrative embodiment. In this illustrative example, root directory R3 534 is associated with identifier 600 stored in memory. Identifier 600 is not yet written to disk.

In this illustrative example, clone CD1 602 of snapshot SD1 518 in FIG. 5 is created. Clone CD1 602 is modifiable in this example. In other words, modifications may be stored in the location of clone CD1 602. As depicted, clone CD1 602 is associated with identifier 604. First portion 605 of identifier 604 takes the value of first portion 607 of identifier 600. Clone CD1 602 points to file A1 506 and file B1 508.

When clone CD1 602 is created, root directory R4 606 is formed and written to disk. Root directory R4 606 is associated with identifier 600. Root directory R4 606 points to directory D2 536, snapshot SD1 518, and clone CD1 602. Further, root directory R4 606 is also associated with identifier 610 stored in memory. Identifier 610 is not yet written to disk. First portion 611 of identifier 610 is set to an incremented value formed by incrementing first portion 607 of identifier 600.

In this illustrative example, modifications may be made to file B1 508 after the creation of clone CD1 602. A new location is identified for these modifications. These modifications are stored in file B3 614 in this new location. File B3 614 is associated with identifier 616. First portion 618 of identifier 616 is set to the value of first portion 607 of identifier 600. The second and third portions of identifier 616 are set to the values for the second and third portions of identifier 514.

When file B3 614 is created, clone CD2 622 is formed and written to disk. Clone CD2 622 is associated with identifier 624. First portion 626 of identifier 624 takes the value of first portion 611 of identifier 610. Clone CD2 622 points to file Al 506 and file B3 614. Additionally, root directory R5 628 is formed and written to disk. Root directory R5 628 is associated with identifier 610. Root directory R5 628 points to directory D2 536, snapshot SD1 518, and clone CD2 622.

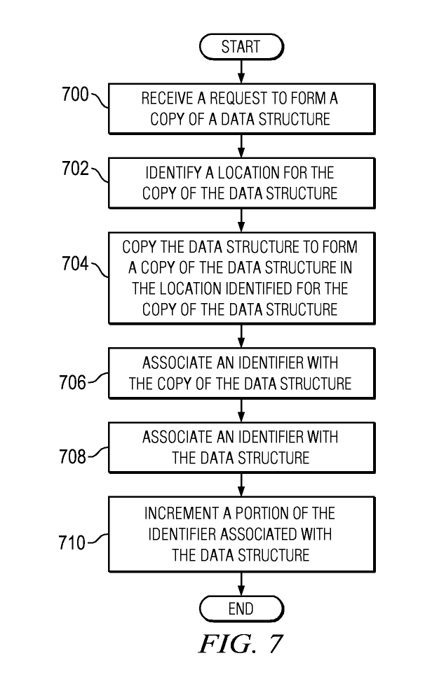

With reference now to FIG. 7, an illustration of a flowchart of a process for managing data is depicted in accordance with an illustrative embodiment. The process illustrated in FIG. 7 may be implemented by data management process 302 in FIG. 3.

The process begins by receiving a request to form a copy of a data structure (step 700). The data structure is within a hierarchy of data structures in this illustrative example. The hierarchy of data structures has a plurality of levels. The data structure belongs to a level within the plurality of levels. The data structure may be, for example, a file, a directory, a subdirectory, a file storage, a root directory, a snapshot, a clone, a location, or some other suitable type of organization of data. In step 700, the copy may be formed to take a snapshot of the data structure, to form a clone of the data structure, or to perform some other suitable operation.

Thereafter, the process identifies a location for the copy of the data structure (step 702). The process copies the data structure to form a copy of the data structure in the location identified for the copy of the data structure (step 704). The copy of the data structure may be, for example, a snapshot or a clone of the data structure.

The process then associates an identifier with the copy of the data structure (step 706). Thereafter, the process associates an identifier with the data structure (step 708).

The process then increments a portion of the identifier associated with the data structure in response to copying the data structure to form the copy of the data structure and associating the identifier with the data structure (step 710), with the process terminating thereafter. The portion of the identifier incremented is the portion associated with the level in which the data structure is located. In some illustrative examples, step 708 may be performed prior to step 704. Step 708 and step 704 may be performed in any order prior to step 710 being performed.

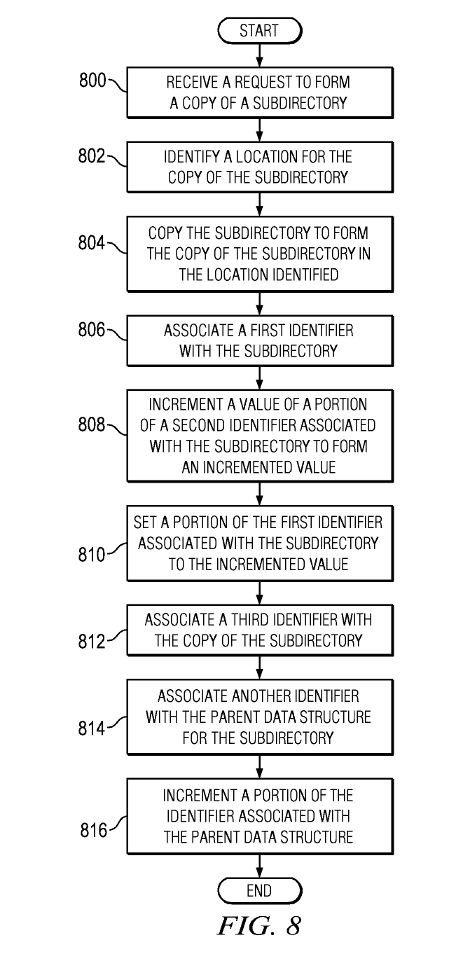

With reference now to FIG. 8, an illustration of a flowchart of a process for managing data is depicted in accordance with an illustrative embodiment. The process illustrated in FIG. 8 may be implemented by data management process 302 in FIG. 3. This process is a more-detailed process for the process illustrated in FIG. 7.

The process begins by receiving a request to form a copy of a subdirectory (step 800). In this illustrative example, the request is to create a snapshot of the subdirectory. In other illustrative examples, requests may be received to form copies for other types of data structures. For example, requests may be received to form copies of files, a root directory, directories, filesets, or other suitable types of data structures.

The subdirectory is in a hierarchy of data structures with a plurality of levels. The process then identifies a location for the copy of the subdirectory (step 802). Thereafter, the process copies the subdirectory to form the copy of the subdirectory in the location identified (step 804).

The process then associates a first identifier with the subdirectory (step 806). The process increments a value of a portion of a second identifier associated with the subdirectory to form an incremented value (step 808). In this illustrative example, this second identifier may be stored in memory or written to disk. The portion of the second identifier is a portion associated with the level in which the subdirectory is located.

The process then sets a portion of the first identifier associated with the subdirectory to the incremented value (step 810). The portion of the first identifier is also associated with the level in which the subdirectory is located. Thereafter, the process associates a third identifier with the copy of the subdirectory (step 812). In some illustrative examples, step 812 may be performed prior to step 806.

Thereafter, the process associates another identifier with the parent data structure for the subdirectory (step 814). In this illustrative example, the parent data structure is a root directory. The process then increments a portion of the identifier associated with the parent data structure (step 816), with the process terminating thereafter.

The flowcharts and block diagrams in the figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

For example, in FIG. 7, if the request received is to form a clone of a data structure, step 710 is omitted. Additionally, in FIG. 8, if the request received is to form a clone of the subdirectory, steps 808 and 810 are omitted. Additionally, other steps, in addition to the ones presented in FIG. 7 and FIG. 8, may be performed to manage the data.

The terminology used herein is for the purpose of describing particular embodiments only and is not intended to be limiting of the invention. As used herein, the singular forms “a”, “an”, and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer usable or computer readable medium providing program code for use by or in connection with a computer or any instruction system. For the purposes of this description, a computer usable or computer readable medium can be any tangible apparatus that can contain, store, communicate, propagate, or transport the program for use by or in connection with the instruction system, apparatus, or device.

The medium can be an electronic, magnetic, optical, electromagnetic, infrared, or semiconductor system (or apparatus or device), or a propagation medium. Examples of a computer readable medium include a semiconductor or solid state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W), and DVD.

A data processing system suitable for storing and/or executing program code will include at least one processor coupled directly or indirectly to memory elements through a system bus. The memory elements can include local memory employed during actual running of the program code, bulk storage, and cache memories, which provide temporary storage of at least some program code in order to reduce the number of times code must be retrieved from bulk storage during running of the code.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, remote printers, or storage devices through intervening networks. Modems, cable modem, and Ethernet cards are just a few of the currently available types of network adapters.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing data, the method comprising:
copying, by a processor unit, a data structure within a hierarchy of data structures to form a copy of the data structure, wherein the data structure belongs to a level within a plurality of levels in the hierarchy of data structures;
associating, by the processor unit, an identifier with the data structure within the hierarchy of data structures; and
responsive to copying the data structure to form the copy of the data structure and associating the identifier with the data structure within the hierarchy of data structures, incrementing, by the processor unit, a portion of the identifier for the data structure, wherein the portion of the identifier that is incremented is based on the level within the plurality of levels in which the data structure is located.

2. The method of claim 1, wherein the copy of the data structure is a snapshot of the data structure and further comprising:
copying the copy of the data structure to form a second copy of the data structure, wherein the second copy of the data structure is a clone of the data structure; and
associating a second identifier with the second copy of the data structure based on the level within the plurality of levels in which the data structure is located.

3. The method of claim 2 further comprising:
responsive to modifying the second copy of the data structure, storing, by the processor unit, a modification for the second copy of the data structure at a location for the second copy of the data structure.

4. The method of claim 1 further comprising:
responsive to modifying the data structure, storing, by the processor unit, a modification for the data structure at a new location to form a second data structure.

5. The method of claim 1, wherein the step of incrementing the portion of the identifier for the data structure comprises:
incrementing a value of a portion of a second identifier associated with the data structure to form an incremented value; and
setting the portion of the identifier for the data structure to the incremented value.

6. The method of claim 5 further comprising:
associating a third identifier with the copy of the data structure, wherein a portion of the third identifier has the value for the portion of the second identifier associated with the data structure.

7. The method of claim 1, wherein the level in which the data structure is located is a first level and further comprising:
associating a second identifier with a second data structure in a second level in the plurality of levels, wherein the second level is above the first level in the hierarchy of data structures.

8. The method of claim 7, wherein the second level is a highest level in the plurality of levels and further comprising:
incrementing the second identifier to form a third identifier; and
associating the third identifier with the second data structure in memory.

9. The method of claim 1, wherein the step of copying, by the processor unit, the data structure within the hierarchy of data structures to form the copy of the data structure comprises:
identifying, by the processor unit, a location for the copy of the data structure;
creating, by the processor unit, the copy of the data structure in the location for the copy of the data structure, wherein the copy of the data structure is a snapshot of the data structure;
associating a header with the copy of the data structure, wherein the header has an identifier for the copy of the data structure; and
creating, by the processor unit, a link from the data structure to the copy of the data structure.

10. The method of claim 1, wherein the copy of the data structure is a clone and wherein a modification to the clone of the data structure is stored in the location identified for the copy of the data structure.

11. The method of claim 1, wherein the data structure is selected from one of a file, a directory, a subdirectory, and a fileset.

12. A data processing system comprising:
a bus;
a communications unit connected to the bus;
a storage device connected to the bus, wherein the storage device includes program code; and
a processor unit connected to the bus, wherein the processor unit runs the program code to copy a data structure within a hierarchy of data structures to form a copy of the data structure, wherein the data structure belongs to a level within a plurality of levels in the hierarchy of data structures; associate an identifier with the data structure within the hierarchy of data structures; and increment a portion of the identifier for the data structure in response to copying the data structure to form the copy of the data structure and associating the identifier with the data structure within the hierarchy of data structures, wherein the portion of the identifier that is incremented is based on the level within the plurality of levels in which the data structure is located.

13. The data processing system of claim 12, wherein the copy of the data structure is a snapshot of the data structure and wherein the processor unit further runs the program code to copy the copy of the data structure to form a second copy of the data structure, wherein the second copy of the data structure is a clone of the data structure; and associate a second identifier with the second copy of the data structure based on the level within the plurality of levels in which the data structure is located.

14. The data processing system of claim 12, wherein the processor unit further runs the program code to store a modification for the data structure at a new location to form a second data structure in response to modifying the data structure.

15. The data processing system of claim 12, wherein in running the program code to increment the portion of the identifier for the data structure, the processor unit runs the program code to increment a value of a portion of a second identifier associated with the data structure to form an incremented value; and set the portion of the identifier for the data structure to the incremented value.

16. A computer program product for managing data comprising:
a computer readable storage medium;
program code, stored on the computer readable storage medium, for copying a data structure within a hierarchy of data structures to form a copy of the data structure, wherein the data structure belongs to a level within a plurality of levels in the hierarchy of data structures;
program code, stored on the computer readable storage medium, for associating an identifier with the data structure within the hierarchy of data structures; and
program code, stored on the computer readable storage medium, for incrementing a portion of the identifier for the data structure in response to copying the data structure to form the copy of the data structure and associating the identifier with the data structure within the hierarchy of data structures, wherein the portion of the identifier that is incremented is based on the level within the plurality of levels in which the data structure is located.

17. The computer program product of claim 16, wherein the copy of the data structure is a snapshot of the data structure and further comprising:
program code, stored on the computer readable storage medium, for copying the copy of the data structure to form a second copy of the data structure, wherein the second copy of the data structure is a clone of the data structure; and
program code, stored on the computer readable storage medium, for associating a second identifier with the second copy of the data structure based on the level within the plurality of levels in which the data structure is located.

18. The computer program product of claim 16, wherein program code, stored on the computer readable storage medium, for incrementing the portion of the identifier for the data structure comprises:
program code, stored on the computer readable storage medium, for incrementing a value of a portion of a second identifier associated with the data structure to form an incremented value; and
program code, stored on the computer readable storage medium, for setting the portion of the identifier for the data structure to the incremented value.

19. The computer program product of claim 18 further comprising:
program code, stored on the computer readable storage medium, for associating a third identifier with the copy of the data structure, wherein a portion of the third identifier has the value for the portion of the second identifier associated with the data structure.

20. The computer program product of claim 16, wherein the program code, stored on the computer readable storage medium, for copying the data structure within the hierarchy of data structures to form the copy of the data structure comprises:
program code, stored on the computer readable storage medium, for identifying, by the processor unit, a location for the copy of the data structure;
program code, stored on the computer readable storage medium, for creating, by the processor unit, the copy of the data structure in the location for the copy of the data structure, wherein the copy of the data structure is a snapshot of the data structure;
program code, stored on the computer readable storage medium, for associating a header with the copy of the data structure, wherein the header has an identifier for the copy of the data structure; and
program code, stored on the computer readable storage medium, for creating, by the processor unit, a link from the data structure to the copy of the data structure.
